(19) United States
(12) Patent Application Publication
(10) Pub. No.: US 2017/0219383 A1
(43) Pub. Date: Aug. 3, 2017

(54) DISPLACEMENT DETECTION UNIT AND ANGULAR VELOCITY DETECTION UNIT

(71) Applicant: TDK CORPORATION, Tokyo (JP)

(72) Inventors: Tsuyoshi UMEHARA, Tokyo (JP); Hiraku HIRABAYASHI, Tokyo (JP); Kunihiro UEDA, Tokyo (JP); Keisuke UCHIDA, Tokyo (JP)

(73) Assignee: TDK CORPORATION, Tokyo (JP)

(21) Appl. No.: 15/414,247

(22) Filed: Jan. 24, 2017

(30) Foreign Application Priority Data
Feb. 2, 2016 (JP) 2016-017853

(51) Int. Cl. G01D 5/165; G01P 3/44; G01D 5/244

(52) U.S. Cl. CPC G01D 5/165; G01D 5/244; G01P 3/44

(57) ABSTRACT

A displacement detection unit includes first and second sensors, an object, and a calculation section. The object includes first and second regions disposed periodically in a first direction, and performs displacement relative to the first and second sensors in the first direction. The first and second sensors detect first and second magnetic field changes in accordance with the displacement of the object and output the detected first and second magnetic field change as first and second signals, respectively. The first and second signals have different phases. The calculation section performs a calculation of an amount of the displacement of the object in the first direction multiple times per one period corresponding to a time period in which the object performs the displacement by an amount of displacement equivalent to a total of a continuous pair of the first and second regions, on a basis of the first and second signals.

### CROSS REFERENCE TO RELATED APPLICATIONS

This application claims the benefit of Japanese Priority Patent Application JP2016-017853 filed Feb. 2, 2016, the entire contents of which are incorporated herein by reference.

### BACKGROUND

The technology relates to a displacement detection unit that detects a displacement of an object by detecting a change in a magnetic field in accordance with the displacement of the object. The technology also relates to an angular velocity detection unit that detects a rotation of an object by detecting a change in a magnetic field in accordance with the rotation of the object.

Rotation detection units are typically installed in encoders, potentiometers, and some other instruments in order to measure a rotation operation of a rotating body. An exemplary rotation detection unit includes a magnetic body, a magnetic detection device, and a bias magnet. For example, reference is made to Japanese Unexamined Patent Application Publications Nos. H8-114411 and 2006-113015. The magnetic body includes a component such as a gear that is rotatable together with the rotating body. The magnetic detection device is disposed in the vicinity of the magnetic body being away from the magnetic body. The bias magnet generates a bias magnetic field.

### SUMMARY

Some rotation detection units may have taken a long time to detect a rotation of a rotating body at an extremely low speed, which is attributed to a limit in decreasing a gear pitch of the rotating body.

It is desirable to provide a displacement detection unit that makes it possible to accurately detect a displacement of an object even at a low speed and an angular velocity detection unit that makes it possible to accurately detect a rotation of an object even at a low speed.

A displacement detection unit according to an embodiment of the technology includes a first sensor, a second sensor, an object, and a calculation section. The object includes a first region and a second region that are disposed periodically in a first direction. The object performs displacement relative to the first sensor and the second sensor in the first direction. The first sensor detects a first magnetic field change in accordance with the displacement of the object, and outputs the detected first magnetic field change as a first signal. The second sensor detects a second magnetic field change in accordance with the displacement of the object, and outputs the detected second magnetic field change as a second signal. The second signal has a phase different from a phase of the first signal. The calculation section performs a calculation of an amount of the displacement of the object in the first direction multiple times per one period. The calculation section performs the calculation on a basis of the first signal and the second signal. The one period corresponds to a time period in which the object performs the displacement by an amount of displacement equivalent to a total of a continuous pair of the first region and the second region.

An angular velocity detection unit according to an embodiment of the technology includes a first sensor, a second sensor, a rotating body, and a calculation section. The rotating body includes a first region and a second region that are disposed periodically in a first direction. The rotating body performs rotation relative to the first sensor and the second sensor in the first direction. The first sensor detects a first magnetic field change in accordance with the rotation of the rotating body, and outputs the detected first magnetic field change as a first signal. The second sensor detects a second magnetic field change in accordance with the rotation of the rotating body, and outputs the detected second magnetic field change as a second signal. The second signal has a phase different from a phase of the first signal. The calculation section performs a calculation of a rotation angle of the rotation of the rotating body in the first direction multiple times per one period. The calculation section performs the calculation on a basis of the first signal and the second signal. The one period corresponds to a time period in which the rotating body performs the rotation by an amount of rotation equivalent to a total of a continuous pair of the first region and the second region.

### BRIEF DESCRIPTION OF THE DRAWINGS

FIG. 1 is a schematic view of an exemplary overall configuration of a rotation detection unit in one embodiment of the technology.

FIG. 2 is a perspective, schematic view of an example of a configuration of a part of the rotation detection unit illustrated in FIG. 1.

FIG. 3 is a circuit diagram illustrating an example of a magnetic sensor illustrated in FIG. 2.

FIG. 4 is an exploded perspective view, in an enlarged manner, of a configuration of a key part of the magnetic sensor illustrated in FIG. 2.

FIG. 5A is a first enlarged diagram of a configuration and an operation of a key part of the rotation detection unit illustrated in FIG. 1.

FIG. 5B is a second enlarged diagram of the configuration and the operation of the key part of the rotation detection unit illustrated in FIG. 1.

FIG. 5C is a third enlarged diagram of the configuration and the operation of the key part of the rotation detection unit illustrated in FIG. 1.

FIG. 6 is an exemplary characteristic diagram that illustrates temporal variations in a rotation angle (an electrical angle) of a gear wheel of the rotation detection unit illustrated in FIG. 1 and a sensor output and a pulse output of the rotation detection unit.

FIG. 7 is a schematic view of an example of a configuration of an object in a first modification.

FIG. 8 is a schematic view of an example of a configuration of an object in a second modification.

FIG. 9A is another exemplary characteristic diagram that illustrates temporal variations in a rotation angle (an electrical angle) of the gear wheel of the rotation detection unit illustrated in FIG. 1 and a sensor output and a pulse output of the rotation detection unit.

FIG. 9B is a further another characteristic diagram that illustrates temporal variations in a rotation angle (an electrical angle) of the gear wheel of the rotation detection unit illustrated in FIG. 1 and a sensor output and a pulse output of the rotation detection unit.

### DETAILED DESCRIPTION

Some embodiments of the technology is described in detail below with reference to the accompanying drawings. The description will be given in the following order.

### 1. Embodiment

A rotation detection unit that detects a rotation and angular velocity of a gear wheel.

### 2. Modification

### 1. Embodiment

### [Configuration of Rotation Detection Unit]

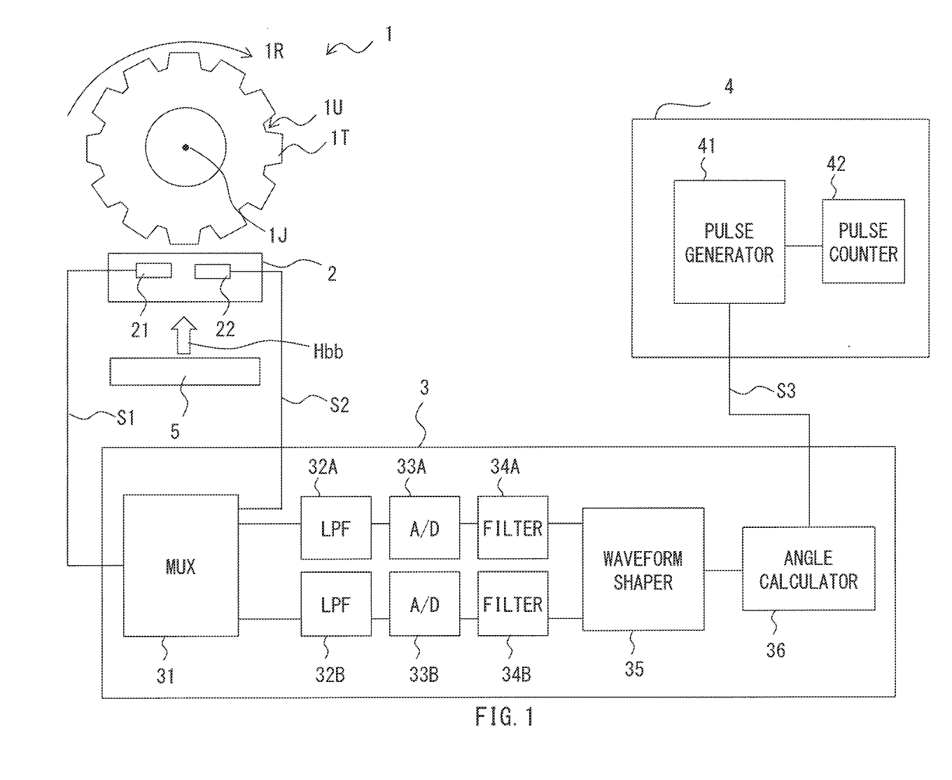

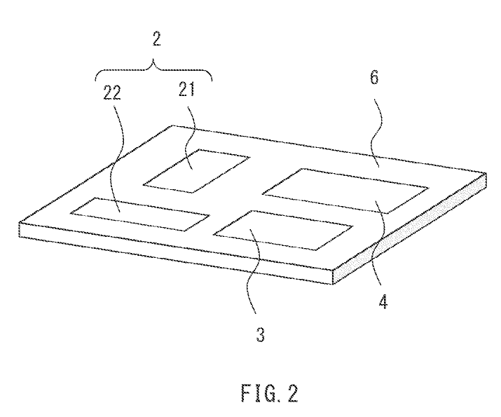

First, a description is given of a configuration of a rotation detection unit in one embodiment of the technology, with reference to FIG. 1 and FIG. 2. FIG. 1 is a schematic view of an exemplary overall configuration of the rotation detection unit. FIG. 2 is a schematic perspective view of an outline of a configuration of a part of the rotation detection unit illustrated in FIG. 1. The rotation detection unit may detect a rotation angle of a rotating body, which is an object to be measured. The rotating body may be in the shape of a bar or a disc, for example. This rotation detection unit may be a so-called gear tooth sensor or a so-called gear wheel sensor. The rotation detection unit may include a gear wheel 1, a sensor section 2, a calculation circuit 3, a pulse output section 4, and a magnet 5, for example. The gear wheel 1 may rotate together with the rotating body. The sensor section 2, the calculation circuit 3, and the pulse output section 4 may be mounted on the same board 6, for example, as illustrated in FIG. 2. However, this mounting configuration may be exemplary and is not limitative. Alternatively, the sensor section 2, the calculation circuit 3, and the pulse output section 4 may be mounted on a plurality of different boards. It is to be noted that the rotation detection unit may correspond to a “displacement detection unit” or an “angular velocity detection unit” in one specific but non-limiting embodiment of the technology.

### (Gear Wheel 1)

The gear wheel 1 may be attached directly or indirectly to the rotating body serving as an object to be measured. This gear wheel 1 may be rotatable around a rotation axis 1J in a direction denoted by an arrow 1R and together with the rotating body. The gear wheel 1 may be a rotating body that rotates in a direction denoted by an arrow 1R. Further, for example, the gear wheel 1 may be provided with a disc-shaped member that has a gear teeth part on its circumference. The gear teeth part may include projections 1T and depressions 1U, each of which is made of a magnetic body and which are alternately disposed at predetermined intervals from about 2 mm to about 7 mm, for example, namely, alternately arrayed in a periodic manner. Due to a rotation operation of the gear wheel 1, the projections 1T and the depressions 1U may be alternately and repeatedly to be present at a location nearest to the sensor section 2. Due to the rotation operation of the gear wheel 1, the gear wheel 1 may change, in a periodic manner, a back bias magnetic field Hbb which serves as an external magnetic field applied to the sensor section 2. In this example, the total number of the projections 1T or the total number of the depressions 1U in the gear wheel 1 is referred to as the number of teeth in the gear wheel 1. The gear wheel 1 may correspond to an “object” in one specific but non-limiting embodiment of the technology. The projection 1T may correspond to a “first region” in one specific but non-limiting embodiment of the technology. The depressions 1U may correspond to a “second region” in one specific but non-limiting embodiment of the technology.

### (Sensor Section 2)

The sensor section 2 may include a magnetic sensor 21 and a magnetic sensor 22. The magnetic sensor 21 detects a change in a magnetic field in accordance with the rotation of the gear wheel 1 and outputs a first signal S1 to the calculation circuit 3. Likewise, the magnetic sensor 22 detects a change in a magnetic field in accordance with the rotation of the gear wheel 1 and outputs a second signal S2 to the calculation circuit 3. The first signal S1 and the second signal S2 may differ in phase from each other. For example, when the first signal S1 represents a variation in a resistance in accordance with sin θ, and the second signal S2 represents a variation in a resistance in accordance with cos θ, where θ is a rotation angle of the gear wheel 1.

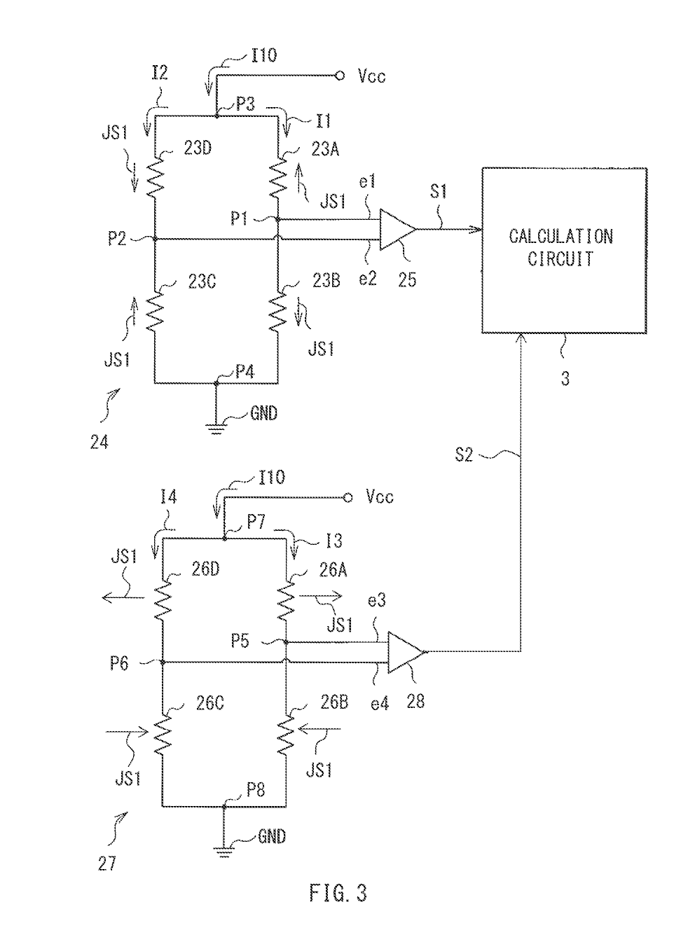

FIG. 3 is a circuit diagram of the sensor section 2. As illustrated in FIG. 3, for example, the magnetic sensor 21 may include a Wheatstone bridge circuit 24 and a differential detector 25. The Wheatstone bridge circuit 24 may be referred to below simply as the bridge circuit 24. The bridge circuit 24 may have four magneto-resistive effect (MR) devices 23 (23A to 23D), for example. Likewise, the magnetic sensor 22 may include a bridge circuit 27 and a differential detector 28. The bridge circuit 27 may include four MR devices 26 (26A to 26D), for example.

In the bridge circuit 24, a first end of the MR device 23A may be coupled to a first end of the MR device 23B at a node P1; a first end of the MR device 23C may be coupled to a first end of the MR device 23D at a node P2; a second end of the MR device 23A may be coupled to a second end of the MR device 23D at a node P3; and a second end of the MR device 23B may be coupled to a second end of the MR device 23C at a node P4. The node P3 may be coupled to a power source Vcc, and the node P4 may be grounded. The nodes P1 and P2 may be coupled to respective input terminals of the differential detector 25. The differential detector 25 may detect a potential difference between the nodes P1 and P2, i.e., a difference between voltage drops in the respective MR devices 23A and 23D. The differential detector 25 may output the detection result to the calculation circuit 3 as the first signal S1. Likewise, in the bridge circuit 27, a first end of the MR device 26A may be coupled to a first end of the MR device 26B at a node P5; a first end of the MR device 26C may be coupled to a first end of the MR device 26D at a node P6; a second end of the MR device 26A may be coupled to a second end of the MR device 26D at a node P7; and a second end of the MR device 26B may be coupled to a second end of the MR device 26C at a node P8. The node P7 may be coupled to the power source Vcc, and the node P8 may be grounded. The nodes P5 and P6 may be coupled to respective input terminals of the differential detector 28. The differential detector 28 may detect a potential difference between the nodes P5 and P6 at a time when a voltage is applied between the node P7 and the node P8, i.e., a difference between voltage drops in the respective MR devices 26A and 26D. The differential detector 28 may output the detection result to the calculation circuit 3 as the second signal S2.

In FIG. 3, arrows denoted by a character “JS1” schematically indicate directions of magnetization of magnetization fixed layers SS1 in the respective MR devices 23A to 23D and 26A to 26D. Details of the magnetization fixed layer SS1 will be described later. Specifically, the resistances of both the MR devices 23A and 23C change in the same direction with a change in a magnetic field induced by an external signal, and the resistances of both the MR devices 23B and 23D change in the direction opposite to the direction in which the MR devices 23A and 23C change, with the change in the magnetic field of the external signal. For example, when the resistances of both the MR devices 23A and 23C increase, the resistances of both the MR devices 23B and 23D decrease. When the resistances of both the MR devices 23A and 23C decrease, the resistances of both the MR devices 23B and 23D increase. Furthermore, with the change in the magnetic field of the external signal, the resistances of the MR devices 26A and 26C may change with their phases shifted by 90° from those of the MR devices 23A to 23D. With the change in the magnetic field of the external signal, the resistances of the MR devices 26B and 26D may change in a direction opposite to that in which the resistances of MR devices 26A and 26C change. Thus, the MR devices 23A to 23D behave in accordance with the following relationship. When the gear wheel 1 rotates, for example, the resistances of the MR devices 23A and 23C increase but the resistances of the MR devices 23B and 23D decrease, within a certain angle range. In this case, the resistances of the MR devices 26A and 26C may change with their phases delayed or leading by 90° relative to those of the changing resistances of the MR devices 23A and 23C. The resistances of the MR devices 26B and 26D may change with their phases delayed or leading by 90° relative to those of the changing resistances of the MR devices 23B and 23D.

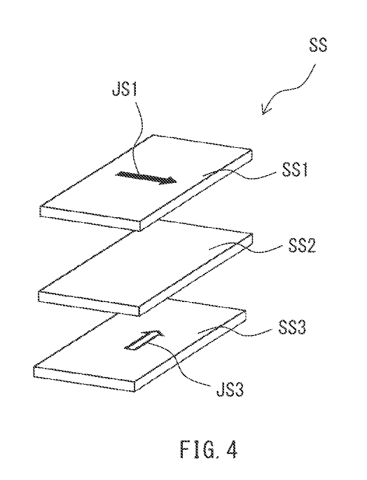

FIG. 4 illustrates an exemplary sensor stack SS, which is a key part of each of the MR devices 23 and 26. The sensor stacks SS in the MR devices 23 and 26 may have substantially the same structure. As illustrated in FIG. 4, the sensor stack SS may have a spin-valve structure in which a plurality of functional films, including a magnetic layer, are stacked. More specifically, the sensor stack SS may include the magnetization fixed layer SS1, an intermediate layer SS2, a magnetization free layer SS3 stacked in this order. The magnetization fixed layer SS1 may have the magnetization JS1 fixed in a constant direction. The intermediate layer SS2 may exhibit no specific direction of magnetization. The magnetization free layer SS3 may have magnetization JS3 that changes with a magnetic flux density of the signal magnetic field. FIG. 4 illustrates a no load state where an external magnetic field such as the back bias magnetic field Hbb is not applied. Each of the magnetization fixed layer SS1, the intermediate layer SS2, and the magnetization free layer SS3 may have either a single-layer structure or a multi-layer structure in which a plurality of layers are stacked.

The magnetization fixed layer SS1 may be made of a ferromagnetic material, examples of which include, but are not limited to, cobalt (Co), a cobalt-iron alloy (CoFe), and a cobalt-iron-boron alloy (CoFeB). It is to be noted that an unillustrated antiferromagnetic layer may be provided on the opposite side of the magnetization fixed layer SS1 to the intermediate layer SS2 so that the antiferromagnetic layer is adjacent to the magnetization fixed layer SS1. This antiferromagnetic layer may be made of an antiferromagnetic material, examples of which include, but are not limited to, a platinum-manganese alloy (PtMn) and an iridium-manganese alloy (IrMn). As one example, the antiferromagnetic layer may be in a state where spin magnetic moments oriented in a positive direction and in the reverse direction completely cancel each other. This antiferromagnetic layer fixes, in the positive direction, the direction of the magnetization JS1 of the magnetization fixed layer SS1 adjacent to the ferromagnetic layer.

For example, when the spin-valve structure of the sensor stack SS has magnetic tunnel junction (MTJ), the intermediate layer SS2 may be a non-magnetic tunnel barrier layer made of magnesium oxide (MgO) and thin enough to allow a tunnel current based on quantum mechanics to flow therethrough. The tunnel barrier layer made of MgO may be obtained through a process such as a sputtering process using a target made of MgO, a process of oxidizing a thin film made of magnesium (Mg), and a reactive sputtering process in which magnesium (Mg) is subjected to sputtering in an oxygen atmosphere, for example. Instead of MgO, the intermediate layer SS2 may be made of an oxide or nitride of aluminum (Al), tantalum (Ta), or hafnium (Hf). The intermediate layer SS2 may also be made of non-magnetic metal such as a platinum group element and copper (Cu). Non-limiting examples of the platinum group element may include ruthenium (Ru) and gold (Au). In this case, the spin-valve structure may serve as a giant magneto resistive effect (GMR) film.

The magnetization free layer SS3 may be a soft ferromagnetic layer made of a material such as a cobalt-iron alloy (CoFe), a nickel-iron alloy (NiFe), and a cobalt-iron-boron alloy (CoFeB), for example.

Each of the MR devices 23A to 23D in the bridge circuit 24 in the magnetic sensor 21 may receive one of a current I1 and a current I2 that are branched at the node P3 from a current I10 supplied from the power source Vcc. A signal e1 outputted from the node P1, and a signal e2 outputted from the node P2 may be supplied to the differential detector 25. In this example, the signal e1 may represent a change in resistance in accordance with A cos (+γ)+B (A and B are constants), and the signal e2 may represent a change in resistance in accordance with A cos (−γ)+B where γ is an angle formed by the magnetization JS1 and the magnetization JS3, for example. In contrast, each of the MR devices 26A to 26D in the bridge circuit 27 in the magnetic sensor 22 may receive one of a current I3 and a current I4 that are branched at the node P7 from the current I10 supplied from the power source Vcc. A signal e3 outputted from the node P5 and a signal e4 outputted from the node P6 may be supplied to the differential detector 28. In this example, the signal e3 may represent a change in resistance in accordance with A sin (+γ)+B, and the signal e4 may represent a change in resistance in accordance with A sin (−γ)+B. Further, the differential detector 25 may supply the first signal S1 to the calculation circuit 3, and the differential detector 28 may supply the second signal S2 to the calculation circuit 3. The calculation circuit 3 may calculate a resistance in accordance with tang. In this example, the angle γ corresponds to a rotation angle θ of the gear wheel 1 with respect to the sensor section 2. Therefore, it is possible to determine the rotation angle θ from the angle γ.

### (Calculation Circuit 3)

As illustrated in FIG. 1, the calculation circuit 3 may include a multiplexer (MUX) 31, low-pass filters (LPFs) 32A and 32B, A/D converters 33A and 33B, filters 34A and 34B, a waveform shaper 35, and an angle calculator 36, for example.

The MUX 31 may be coupled to both the magnetic sensors 21 and 22 and receive the first signal S1 from the magnetic sensor 21 and the second signal S2 from the magnetic sensor 22.

The waveform shaper 35 may shape the waveform of the first signal S1 supplied from the magnetic sensor 21 and the waveform of the second signal S2 supplied from the magnetic sensor 22. The waveform shaper 35 may include a detection circuit and a compensation circuit, for example. The detection circuit may detect a factor such as a difference in offset voltage and a difference in amplitude, and a difference between a relative angle at which the gear wheel 1 forms with the magnetic sensor 21 and a relative angle at which the gear wheel 1 forms with the magnetic sensor 22, for example. The compensation circuit may compensate for the detected difference.

The angle calculator 36 may be an IC circuit that calculates a displacement amount, or the rotation angle θ, of the gear wheel 1 in the direction denoted by the arrow 1R on the basis of the first signal S1 and the second signal S2. When one period is set as a time period in which the gear wheel 1 performs the displacement (rotation) of one gear pitch, namely, performs the displacement (rotation) by the rotation angle (mechanical angle) equivalent to the total of a continuous pair of projection 1T and depression 1U, the angle calculator 36 may perform the calculation of the rotation angle θ “n” times per one period, where “n” is any integer of 2 or greater. FIG. 1 illustrates an example in which the gear wheel 1 has twelve projections 1T and twelve depressions 1U alternately arranged. In this example case, the rotation angle (mechanical angle) θ corresponding to one gear pitch may be about 30°. The angle calculator 36 may assign one gear pitch, which corresponds to a mechanical angle of about 30° in this case, to an electrical angle in a range from 0° to 360° both inclusive, for example and thereby calculate the rotation angle θ in relation to any of the electrical angles. Further, the angle calculator 36 may output a third signal S3 to the pulse output section 4. The third signal S3 may contain information regarding the calculated displacement amount, or the calculated rotation angle θ.

### (Pulse Output Section 4)

As illustrated in FIG. 1, the pulse output section 4 may include a pulse generator 41 and a pulse counter 42. The pulse generator 41 may be coupled to the angle calculator 36 and receive the third signal S3 from the angle calculator 36. Every time the angle calculator 36 calculates the displacement amount, or the rotation angle θ, the pulse generator 41 may generate a pulse and supply the generated pulse to the pulse counter 42. The pulse counter 42 may count the number of pulses generated per unit time, thereby determining a displacement amount, or the rotation angle θ, per unit time of the gear wheel 1. In other words, the pulse counter 42 may determine the angular velocity of the gear wheel 1.

### (Magnet 5)

The magnet 5 may be positioned on the opposite side of the sensor section 2 to the gear wheel 1. The magnet 5 may apply the back bias magnetic field Hbb to both the gear wheel 1 and the sensor section 2. The sensor section 2 may detect a change in the back bias magnetic field Hbb using the magnetic sensors 21 and 22.

### [Operation and Working of Rotation Detection Unit]

The rotation detection unit in the present embodiment may detect the rotation of the gear wheel 1 using the sensor section 2, the calculation circuit 3, the pulse output section 4, and the magnet 5.

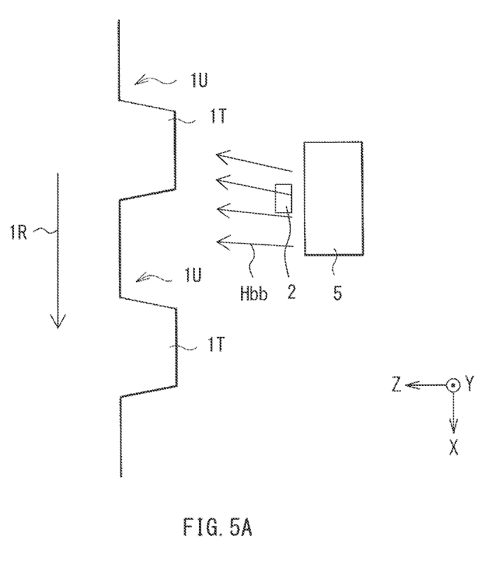

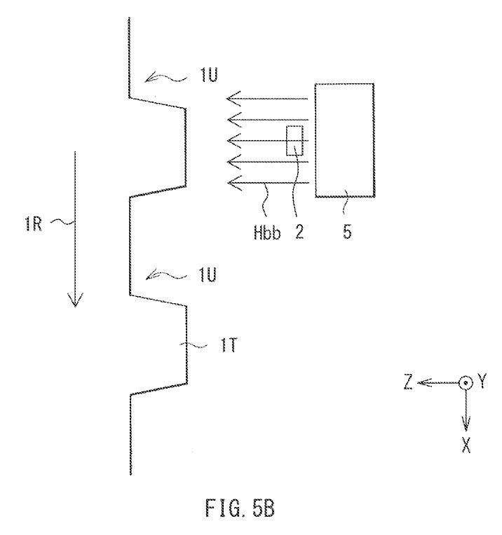

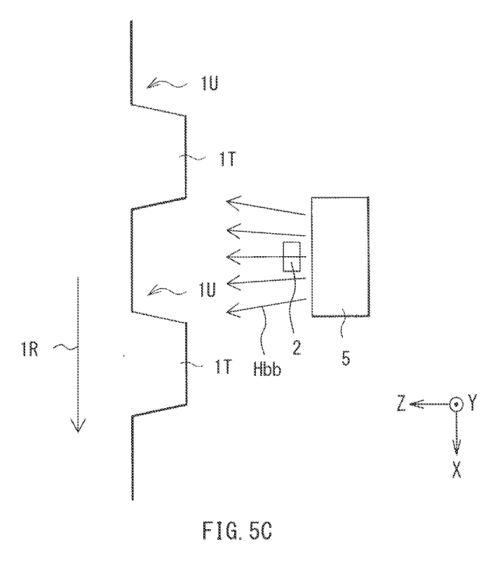

In the rotation detection unit, for example, when the gear wheel 1 that has been in the state of FIG. 5A rotates in the direction denoted by the arrow 1R, the projections 1T and the depressions 1U in the gear wheel 1 may be alternately face the sensor section 2. At that time, when the projection 1T, made of a magnetic body, approaches the sensor section 2 as illustrated in FIG. 5B, for example, the magnetic flux of the back bias magnetic field Hbb applied from the magnet 5 positioned behind the sensor section 2 may concentrate on this projection 1T. In other words, the magnetic flux may spread out at a small extent in the X-axis direction, so that the X component contained in the back bias magnetic field Hbb becomes relatively small. In contrast, when the projection 1T is away from the sensor section 2 and in turn the depression 1U approaches the sensor section 2 as illustrated in FIG. 5C, for example, a part of the magnetic flux of the back bias magnetic field Hbb may travel toward the projections 1T on both sides of the depression 1U. In other words, the magnetic flux may spread out in a great extent in the X-axis direction, so that the X component contained in the back bias magnetic field Hbb becomes relatively great. With this change in the X component contained in the back bias magnetic field Hbb, the directions of the magnetizations JS3 of the magnetization free layers SS3 in the respective sensor stacks SS of the sensor section 2 may change. The change in directions of the magnetizations JS3 may cause resistances of the respective MR devices 23A to 23D and 26A to 26D to change. Therefore, by making use of the changes in the resistances of the respective MR devices 23A to 23D and 26A to 26D, it is possible to detect the rotation of the gear wheel 1.

When the first signal S1 supplied from the magnetic sensor 21 is supplied to the calculation circuit 3, the first signal S1 may pass through the MUX 31, the LPF 32A, the A/D converter 33A, and the filter 34A to be supplied to the waveform shaper 35. Likewise, when the second signal S2 supplied from the magnetic sensor 22 is supplied to the calculation circuit 3, the second signal S2 may pass through the MUX 31, the LPF 32B, the A/D converter 33B, and the filter 34B to be supplied to the waveform shaper 35. The waveform shaper 35 may perform compensation on the first signal S1 and the second signal S2 to compensate for a difference such as a difference in offset voltage, a difference in amplitude, and a difference between a relative angle at which the gear wheel 1 forms with the magnetic sensor 21 and a relative angle at which the gear wheel 1 forms with the magnetic sensor 22, for example. In this way, the waveform shaper 35 may shape the waveforms of the first signal S1 and the second signal S2. Thereafter, the angle calculator 36 may calculate the displacement amount, or the rotation angle θ, of the gear wheel 1 in the direction denoted by the arrow 1R on the basis of the first signal S1 and the second signal S2. Further, the angle calculator 36 may supply the third signal S3 to the pulse generator 41. The pulse generator 41 may generate a pulse and supply the generated pulse to the pulse counter 42 every time the angle calculator 36 calculates the displacement amount, or the rotation angle θ. The pulse counter 42 may count the number of pulses generated per unit time, thereby determining the displacement amount, or the rotation angle θ, per unit time of the gear wheel 1. In other words, the pulse counter 42 may determine the angular velocity of the gear wheel 1.

In this example, the pulse output section 4 may output the pulse to the outside when the rotation angle θ per unit time of the gear wheel 1 in the direction denoted by the arrow 1R is equal to or more than a preset reference value. This configuration makes it possible to avoid more easily an occurrence of a false detection of the rotation of the gear wheel 1 due to a vibration of the gear wheel 1 in a static state, for example.

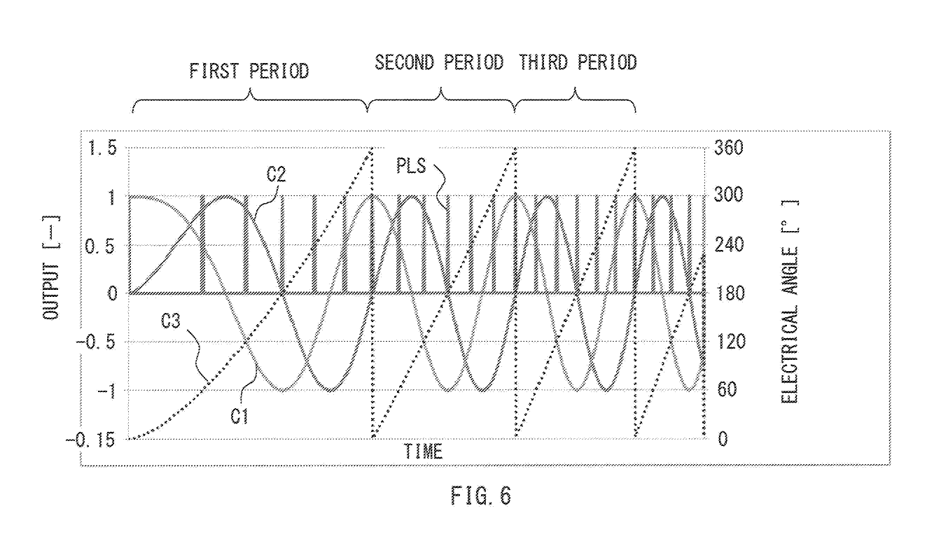

A detailed description will be given below of an operation of detecting a rotation of the gear wheel 1, with reference to FIG. 6. In FIG. 6, the horizontal axis represents an elapsed time; the left vertical axis represents outputs of the magnetic sensors 21 and 22; and the right vertical axis represents an electrical angle. The description is given below referring to an example case where the gear pitch of the gear wheel 1 corresponds to a mechanical angle of 60°, i.e., the gear wheel 1 has six teeth, or six projections 1T. Further, one period is set to correspond to the mechanical angle of 60°, and this one period is expressed by electrical angles in a range from 0° to 360° both inclusive. A curve C1 may be the waveform of the first signal S1 output from the magnetic sensor 21. A curve C2 may be the waveform of the second signal S2 output from the magnetic sensor 22. A curve C3 may be a waveform representing a change in electrical angle of the gear wheel 1. A character PLS denotes a waveform of a pulse output from the pulse generator 41. A period of the waveform of each of the first signal S1 and the second signal S2 respectively output from the magnetic sensors 21 and 22 may also correspond to the mechanical angle of 60°. On the basis of the first signal S1 from the magnetic sensor 21 and the second signal S2 from the magnetic sensor 22 that have different phases from each other, the electrical angle may be allowed to be determined. As described above, the direction of the magnetization J53 of the magnetization free layer SS3 in each of the sensor stacks SS in the sensor section 2 may change in accordance with the change in the X component contained in the back bias magnetic field Hbb. One reason for this is that, since the first signal S1 represents a change in resistance in accordance with to A cos θ+B (A and B are constants) and the second signal S2 represents a change in resistance in accordance with A sin θ+B, for example, the calculation circuit 3 may calculate a resistance in accordance with tan θ.

In the present example, as illustrated in FIG. 1, the calculation circuit 3 may calculate the rotation angle θ of the gear wheel 1 in the direction denoted by the arrow 1R every time the electrical angle becomes 60°, and the pulse generator 41 may generate the single pulse PLS every time the electrical angle becomes 60°. More specifically, an existing gear tooth sensor outputs a single pulse in relation to one gear pitch. However, the rotation detection unit in this embodiment may perform the calculation of the rotation angle θ and generation of the pulse PLS multiple times in relation to one gear pitch, or per one period.

### [Effect of Rotation Detection Unit]

According to the present embodiment, the time period in which the gear wheel 1 performs the displacement (rotation) of one gear pitch may be set as one period. Further, the calculation of the rotation angle θ of the gear wheel 1 in the direction denoted by the arrow 1R may be performed multiple times per one period. This makes it possible to detect a rotation of a gear wheel at an earlier stage than that of performing the calculation of the rotation angle only once per one period. Moreover, the generation of the pulse PLS may be performed multiple times per one period, and the pulse counter 42 may count the number of pulses PLS generated per unit time, thereby determining the angular velocity of the gear wheel 1. Therefore, the rotation detection unit in the present embodiment makes it possible to detect accurately the rotation and the angular velocity of the gear wheel 1 even when the gear wheel 1 rotates at a low speed.

### 2. Modification

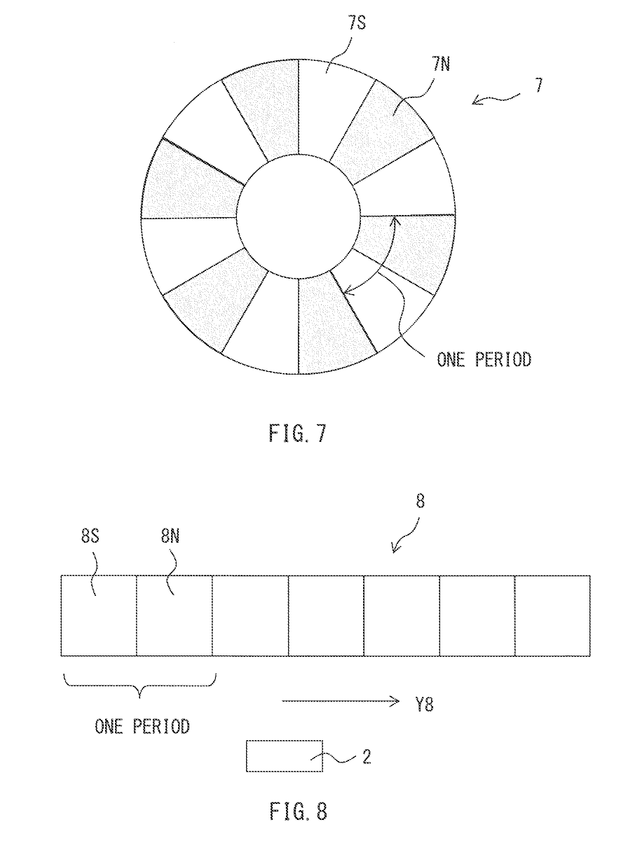

The technology has been described above referring to some embodiments. However, the technology is not limited to the foregoing embodiments and may be varied in various ways. As one example, the “object” is described as a gear wheel as an example in the foregoing embodiment. However, the “object” is not limited to a gear wheel. Alternatively, the object may be a magnet 7 having a circular shape which has S-pole regions 7S as first regions and N-pole regions 7N as second regions, for example, as illustrated in FIG. 7. The first regions and the second regions may be alternately arranged along the circumference of the magnet 7 at constant intervals, namely, alternately arrayed in a periodic manner, for example, as illustrated in FIG. 7. In this case, the magnet 5 that applies a bias magnetic field may not be necessary. Alternately, the object may be a magnet 8 that is in the shape of a bar and extends in a direction denoted by an arrow Y8, for example, as illustrated in FIG. 8. The magnet 8 may have S-pole regions 8S and N-pole regions 8N alternately arranged in the direction denoted by the arrow Y8 and at constant intervals, namely, alternately arrayed in a periodic manner. In addition, the magnet 8 may be displaced or linearly move relative to the sensor section 2 in the direction denoted by the arrow Y8. When the magnet 7 is used as the object, one period may correspond to a time period in which the magnet 7 performs the displacement (rotation) by a displacement amount (a rotation angle) equivalent to the total of a continuous pair of one S-pole region 7S and one N-pole region 7N. When the magnet 8 is used as the object, one period may correspond to a time period in which the magnet 8 performs the displacement (linear movement) by a displacement amount (a linearly moving distance) equivalent to the total of a continuous pair of one S-pole region 8S and one N-pole region 8N.

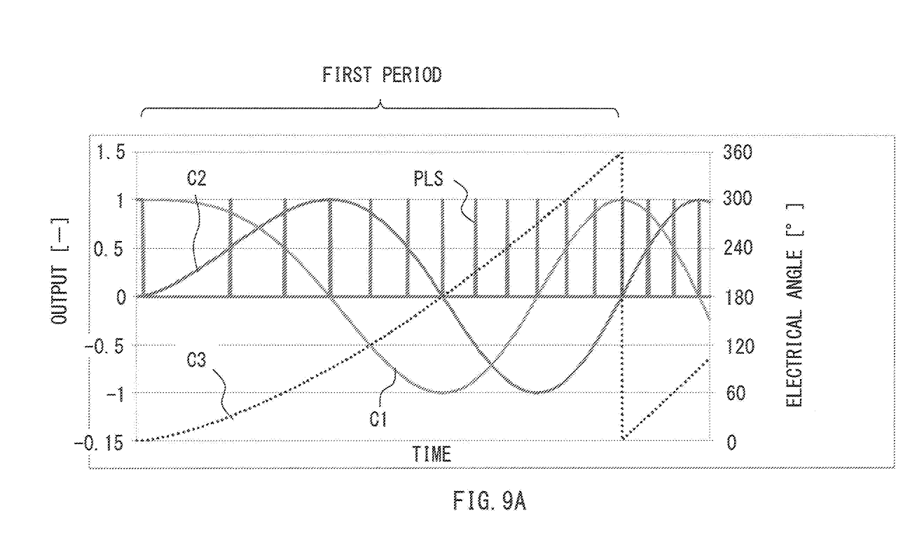

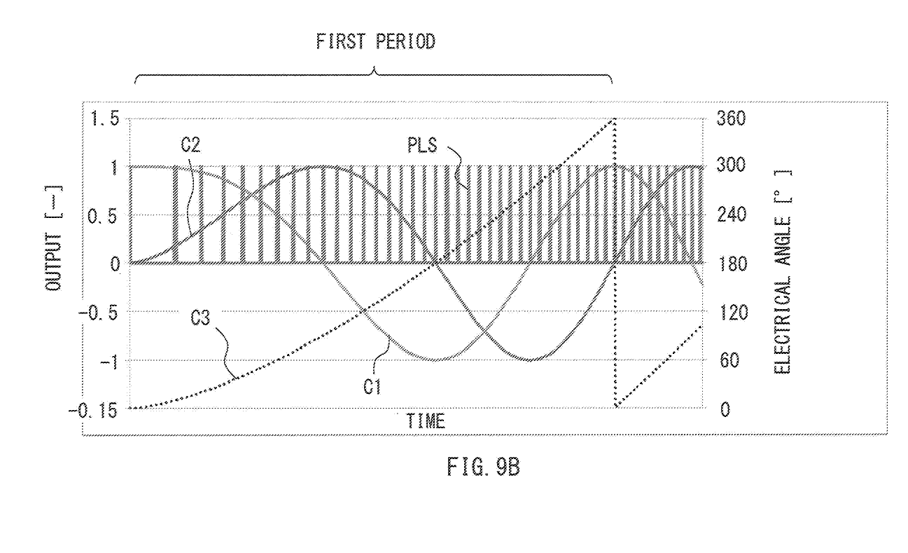

In the foregoing embodiment, the calculation of the rotation angle θ of the gear wheel 1 and the generation of the pulse PLS are performed six times in relation to one gear pitch of the gear wheel 1. However, this may be exemplary, and is not limitative. As one alternative example, the calculation of the rotation angle θ of the gear wheel 1 and the generation of the pulse PLS may be performed twelve or thirty six times in relation to one gear pitch, as illustrated in FIG. 9A and FIG. 9B. By increasing the number of the calculation of the rotation angle θ of the gear wheel 1 and the generation of the pulse PLS to be performed, it is possible to detect a rotation and angular velocity of the gear wheel 1 at an earlier stage even when the gear wheel 1 rotates at a low speed.

In the foregoing embodiment, the rotation detection unit includes two sensors. However, the number of sensors is not limited to two. The rotation detection unit may include three or more sensors. It is to be noted that the sensors to be provided are required to output signals having different phases from each other.

The foregoing embodiment is described referring to the example case in which the “object” is the gear wheel 1, which is a rotating body that rotates in the direction denoted by the arrow 1R. However, the object is not limited to a gear wheel. As an alternative example, the “object” may be a so-called linear scale that linearly extends in a first direction. The linear scale may include S-pole regions and N-pole regions alternately arranged in the first direction at constant intervals, for example. A displacement detection unit in one embodiment of the technology may include the linear scale described above, a first sensor, and a second sensor. The first and second sensors may be disposed in the vicinity of the linear scale. The linear scale may be displaceable relative to the first and second sensors in the first direction. The foregoing displacement detection unit provided with the foregoing linear scale also achieves effects similar to those of the displacement detection unit provided with the rotating body (the gear wheel 1), by performing calculation of a displacement amount of the object (the linear scale) in the first direction multiple times per one period, where the one period is set as a time period in which the object (the linear scale) performs the displacement by an amount of displacement equivalent to the total of a continuous pair of S-pole region and N-pole region.

It should be understood by those skilled in the art that various modifications, combinations, sub-combinations and alterations may occur depending on design requirements and other factors insofar as they are within the scope of the appended claims or the equivalents thereof.

It is possible to achieve at least the following configurations from the above-described example embodiments of the technology.

(1)

A displacement detection unit including:

a first sensor;

a second sensor;

an object including a first region and a second region that are disposed periodically in a first direction, the object performing displacement relative to the first sensor and the second sensor in the first direction; and

a calculation section,

the first sensor detecting a first magnetic field change in accordance with the displacement of the object, and outputting the detected first magnetic field change as a first signal,

the second sensor detecting a second magnetic field change in accordance with the displacement of the object, and outputting the detected second magnetic field change as a second signal, the second signal having a phase different from a phase of the first signal,

the calculation section performing a calculation of an amount of the displacement of the object in the first direction multiple times per one period, the calculation section performing the calculation on a basis of the first signal and the second signal, the one period corresponding to a time period in which the object performs the displacement by an amount of displacement equivalent to a total of a continuous pair of the first region and the second region.

(2)

The displacement detection unit according to (1), wherein the object includes one of a gear teeth part and a ferromagnetic part, the gear teeth part including a plurality of projections and a plurality of depressions disposed alternately, the projections each serving as the first region, the depressions each serving as the second region, the ferromagnetic part including a plurality of N-pole regions and a plurality of S-pole regions disposed alternately, the N-pole regions each serving as the first region, the S-pole regions each serving as the second region.

(3)

The displacement detection unit according to (1) or (2), further including a pulse output section including a pulse generator that generates a pulse every time the calculation of the amount of the displacement of the object in the first direction is performed.

(4)

The displacement detection unit according to (3), wherein

the first region comprises n-number of first regions, and the second region comprises n-number of second regions, where “n” is an integer of two or greater,

the object is a rotating body including the n-number of first regions and the n-number of second regions that are disposed alternately, and

the pulse generator generates the pulse comprising m-number of pulses within the one period, where “m” is an integer of two or greater.

(5)

The displacement detection unit according to (3) or (4), wherein the pulse output section outputs the pulse to an outside when the amount of the displacement per unit time is equal to or more than a reference value.

(6)

The displacement detection unit according to any one of (1) to (5), wherein the calculation section further includes a waveform shaper that shapes a waveform of the first signal and a waveform of the second signal.

(7)

An angular velocity detection unit including:

a first sensor;

a second sensor;

a rotating body including a first region and a second region that are disposed periodically in a first direction, the rotating body performing rotation relative to the first sensor and the second sensor in the first direction; and

a calculation section,

the first sensor detecting a first magnetic field change in accordance with the rotation of the rotating body, and outputting the detected first magnetic field change as a first signal,

the second sensor detecting a second magnetic field change in accordance with the rotation of the rotating body, and outputting the detected second magnetic field change as a second signal, the second signal having a phase different from a phase of the first signal,

the calculation section performing a calculation of a rotation angle of the rotation of the rotating body in the first direction multiple times per one period, the calculation section performing the calculation on a basis of the first signal and the second signal, the one period corresponding to a time period in which the rotating body performs the rotation by an amount of rotation equivalent to a total of a continuous pair of the first region and the second region.

According to one embodiment of the technology, a displacement detection unit sets, as one period, a time period in which an object performs a displacement by an amount of displacement equivalent to a total of a continuous pair of a first region and a second region. The displacement detection unit performs a calculation of an amount of the displacement of the object in the first direction multiple times per one period. This allows the displacement of the object to be detected earlier than that in a case where the calculation of the amount of displacement of the object is performed once per one period.

According to one embodiment of the technology, an angular velocity detection unit sets, as one period, a time period in which a rotating body performs a rotation by an amount of rotation equivalent to a total of a continuous pair of a first region and a second region. The angular velocity detection unit performs a calculation of an amount of the rotation of the rotating body in the first direction multiple times per one period. This allows the rotation of the rotating body to be detected earlier than that in a case where the calculation of the amount of rotation of the rotating body is performed once per one period.

According to a displacement detection unit of one embodiment of the technology, a calculation of an amount of displacement of an object in a first direction is performed multiple times in one period. As a result, it is possible to detect accurately the displacement of the object even when the displacement of the object is performed at a low speed. According to an angular velocity detection unit of one embodiment of the technology, a calculation of an amount of rotation of a rotating body in a first direction is performed multiple times in one period. As a result, it is possible to detect accurately the rotation of the rotating body even when the rotation of the rotating body is performed at a low speed.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A displacement detection unit comprising:
a first sensor;
a second sensor;
an object including a first region and a second region that are disposed periodically in a first direction, the object performing displacement relative to the first sensor and the second sensor in the first direction; and
a calculation section,
the first sensor detecting a first magnetic field change in accordance with the displacement of the object, and outputting the detected first magnetic field change as a first signal,
the second sensor detecting a second magnetic field change in accordance with the displacement of the object, and outputting the detected second magnetic field change as a second signal, the second signal having a phase different from a phase of the first signal,
the calculation section performing a calculation of an amount of the displacement of the object in the first direction multiple times per one period, the calculation section performing the calculation on a basis of the first signal and the second signal, the one period corresponding to a time period in which the object performs the displacement by an amount of displacement equivalent to a total of a continuous pair of the first region and the second region.

2. The displacement detection unit according to claim 1, wherein the object includes one of a gear teeth part and a ferromagnetic part, the gear teeth part including a plurality of projections and a plurality of depressions disposed alternately, the projections each serving as the first region, the depressions each serving as the second region, the ferromagnetic part including a plurality of N-pole regions and a plurality of S-pole regions disposed alternately, the N-pole regions each serving as the first region, the S-pole regions each serving as the second region.

3. The displacement detection unit according to claim 1, further comprising a pulse output section including a pulse generator that generates a pulse every time the calculation of the amount of the displacement of the object in the first direction is performed.

4. The displacement detection unit according to claim 3, wherein
the first region comprises n-number of first regions, and the second region comprises n-number of second regions, where “n” is an integer of two or greater,
the object is a rotating body including the n-number of first regions and the n-number of second regions that are disposed alternately, and
the pulse generator generates the pulse comprising m-number of pulses within the one period, where “m” is an integer of two or greater.

5. The displacement detection unit according to claim 3, wherein the pulse output section outputs the pulse to an outside when the amount of the displacement per unit time is equal to or more than a reference value.

6. The displacement detection unit according to claim 1, wherein the calculation section further includes a waveform shaper that shapes a waveform of the first signal and a waveform of the second signal.

7. An angular velocity detection unit comprising:
a first sensor;
a second sensor;
a rotating body including a first region and a second region that are disposed periodically in a first direction, the rotating body performing rotation relative to the first sensor and the second sensor in the first direction; and
a calculation section,
the first sensor detecting a first magnetic field change in accordance with the rotation of the rotating body, and outputting the detected first magnetic field change as a first signal,
the second sensor detecting a second magnetic field change in accordance with the rotation of the rotating body, and outputting the detected second magnetic field change as a second signal, the second signal having a phase different from a phase of the first signal,
the calculation section performing a calculation of a rotation angle of the rotation of the rotating body in the first direction multiple times per one period, the calculation section performing the calculation on a basis of the first signal and the second signal, the one period corresponding to a time period in which the rotating body performs the rotation by an amount of rotation equivalent to a total of a continuous pair of the first region and the second region.
